(19) United States
(12) Patent Application Publication
(10) Pub. No.: US 2001/0046380 A1
(43) Pub. Date: Nov. 29, 2001

(54) Submersible heater

(75) Inventor: Fred LeFebvre JR., Mentor, OH (US)

Correspondence Address: WATTS, HOFFMANN, FISHER & HEINKE CO., L.P.A., P.O. Box 99839, Cleveland, OH, 44199-0839, US

(73) Assignee: Cleveland Process Corporation

(21) Appl. No.: 09/775,004

(22) Filed: Feb. 1, 2001

Related U.S. Application Data
(60) Provisional application No. 60/179,530, filed on Feb. 1, 2000.

(51) Int. Cl. H05B 3/78; F24H 1/20

(52) U.S. Cl. 392/501; 392/497; 219/544

(57) ABSTRACT

A portable, submersible heater for heating water in an aquaculture water container by resting the heater on a bottom surface of the container includes an electric resistance heater enclosed in a cylindrically shaped heater body, a pair of standoff plates fixed in proximity of either end of the heater body for preventing contact between the heater body and the bottom surface of the aquaculture container regardless of the orientation of the heater within the container and a power cord connected to the resistance heater and entering the heater body through a water tight connector at a first end of the heater body. The cord has an external cord section located outside the heater body and an internal cord section located within the heater body. A thermal protection device in electrical communication with the resistance heater allows the heater to cool in when the water level falls below the heater while automatically restoring power to the heater after a power outage. Multiple sealing means prevent water from entering the heater body and include a sealant material disposed within the heater body at the first end of the heater body and an internal seal disposed within the connector for sealing around the external cord section. The connector comprises a sealing thread portion for engaging the first end of the heater body, and threaded connector is fixed to the first end of the heater body for providing sealing engagement with the sealing thread portion of the connector. A strain relieving feature on the connector transfers a pulling force on the external cord section away from the internal cord section. A removable mounting plate can be installed on the heater to accommodate mounting the heater to the side of the tank.

### TECHNICAL FIELD

The present invention relates generally to heaters for use in heating liquids and in particular a portable, submersible heater for heating aquaculture tanks and ponds.

### BACKGROUND

Large scale aquatic habitats have become increasingly popular for use in aquaculture and indoor/outdoor landscaping. For example, fish and seafood “farms” provide fresh food to groceries and restaurants all around the world. These farms grow aquatic creatures in large tanks having optimal environments for desired characteristics such as speed of growth, size, and flavor. Artificial fish ponds are often installed as part of a landscaping scheme and may house decorative plants and fish, such as koi. As with aquaculture, landscaping ponds require proper environmental control to provide a suitable environment for the aquatic life they support.

A critical parameter of any aquatic habitat is the water temperature. Electric immersion heaters are often used to provide the necessary heat to a tank or pond. These electric immersion heaters generally mount on the side of the tank or pond and are only partially submerged. The power cord enters the heaters at the unsubmerged portion of the heater due to difficulties in sufficiently sealing the connection between the cord and the heater to allow total submersion. Because the heaters are only partially submerged, their effectiveness may be dependent on the water level, requiring controls which monitor the tank or pond level. In addition, because they must mount to the side of the tank or pond, the user is limited in where he or she may install the heater.

Light weight submersible heaters are available for use in small home aquariums. These heaters provide limited sealing around the cord/heater interface and are designed for careful, relatively permanent installation in a predetermined orientation. If the seal between the cord and heater is compromised, water or air may enter the heater, causing improper heater operation, failure or electric shock. For this reason, light weight submersible heaters must be handled with caution and as such are not suitable for large scale use in aquaculture where they may be moved quite often and where proper heating protects relatively large investments in aquatic life. In addition, submersible heaters are not easily adapted to be mounted on the side of a tank.

Many commercially available heaters provide thermal protection against overheating caused by a low water level condition in the tank or pond. Because the water acts as a heat sink for the heater, when the water level sinks below the heater hot zone the temperature of the heater increases. The increase in temperature can result in damage to the heater or tank surfaces. Traditional bi-metal type circuit breakers have been used to prevent overheating of heater elements in low water, but because they cycle between conducting and non-conducting modes during the overheat condition, the heater is not cooled and damage may still result. Some heater designs attempt to prevent this cycling by requiring a manual reset before power can be restored to the heater after the bi-metal device initially trips. A disadvantage to a manual reset is that in the event of a power outage, the heater remains disabled until an operator can reset the unit even though the heater is functioning properly. This can allow a tank to cool to a harmful temperature due to a brief interruption in power that occurs when the tank is not being monitored.

### SUMMARY OF THE INVENTION

The present invention provides a new and improved heating apparatus for heating water in aquaculture tanks and ponds. The invention is well suited for commercial use in large containers and is resistant to rough handling while being easy to install.

In accordance with the present invention, a portable, submersible heater for heating water in an aquaculture water container is provided. The heater comprises an electric resistance heater enclosed in a heater body and at least one standoff member fixed to the heater body for preventing contact between the heater body and a surface of the container. A power cord is connected to the resistance heater and enters the heater body through a cord to heater interface. The power cord has an external cord section located outside the heater body and an internal cord section located within the heater body. Multiple sealing means are provided for preventing water from entering the heater body at the cord to heater interface. Strain relief means for transferring a pulling force on the external cord section away from the internal cord section is also provided.

In accordance with an embodiment of the present invention, the at least one standoff member is configured such that the standoff member prevents contact between the heater body and the container surfaces regardless of the orientation of the heater within the container.

In an exemplary embodiment, the heater body is cylindrically shaped and the standoff member comprises a pair of standoff plates disposed near either end of the body. The cord to heater interface comprises a water tight connected disposed at a first end of the heater body. The multiple sealing means include a sealant material disposed within the heater body at the first end of the heater body and an internal seal disposed within the connector for sealing around the external cord section. The connector comprises a sealing thread portion for engaging the first end of the heater body. A threaded connector is fixed to the first end of the heater body for providing water tight sealing engagement with the sealing thread portion of the connector.

In an embodiment, the cord to heater interface comprises a water tight connector and the strain relief means comprises a mesh sleeve that is disposed closely around the external cord section and is connected to the water tight connector such that when a pulling force is applied to the external cord section, the mesh sleeve tightens and grips the cord thereby transferring the pulling force to the connector instead of the internal cord section. According to an embodiment of the present invention, a controller is connected to the power cord for controlling the operation of the heater.

In an exemplary embodiment, the cord to heater interface comprises a water tight connector that includes a strain relief feature. The threaded connector has a threaded portion outside of the heater that has an insulation engaging structure at a distal end from the heater through which the power cord is run into the heater. An internally threaded clamping nut having an approximately complimentary internal shape to the insulation engaging structure threadedly engages the threaded portion and the insulation engaging structure to clamp the insulation engaging structure around the insulation of the wire to transfer any pulling force to the connector instead of the internal cord section.

In an alternative embodiment, a portable submersible heater in accordance with the present invention includes a thermal protection device in electrical communication with the resistance heater. The thermal protection device has a resistor electrically connected in parallel with a bi-metal switch having a trip temperature above which the switch moves to an open circuit condition and a reset temperature below which the switch conducts current. The resistor generates heat when power is being supplied to the resistance heater and the switch is in the open circuit condition to maintain the temperature of the switch above the reset temperature. In an exemplary embodiment, the heater has a mounting member including a stamped metal plate having an opening sized to have a force fit with the heater body to allow for relatively easy installation when a tank side mount configuration is desired. In this embodiment, the power cord protrudes radially from heater and the standoffs include rubber bumper strips along their edges to prevent damage to the tank.

Additional features of the invention will become apparent and a fuller understanding obtained by reading the following detailed description made in connection with the accompanying drawings.

### BRIEF DESCRIPTION OF THE DRAWINGS

FIG. 1 is perspective view of an aquaculture heating system in accordance with the present invention;

FIG. 2 is a cross section view of the portable, submersible heater of the heating system of FIG. 1;

FIG. 3A is an exploded side view of the connector of the heater of FIG. 2;

FIG. 3B is an exploded side view of an alternative connector;

FIG. 4 is an enlarged fragmentary view of the heater of FIG. 2;

FIG. 5A a side view of an alternative embodiment of a submersible heater in accordance with the present invention;

FIG. 5B is an enlarged top view of the mounting plate of the heater of FIG. 5A;

FIG. 6 is a cross section view of the heater of FIG. 5A; and

FIG. 7 is a schematic view of the thermal protection device of the heater of FIG. 5A.

### DETAILED DESCRIPTION OF THE PREFERRED EMBODIMENTS

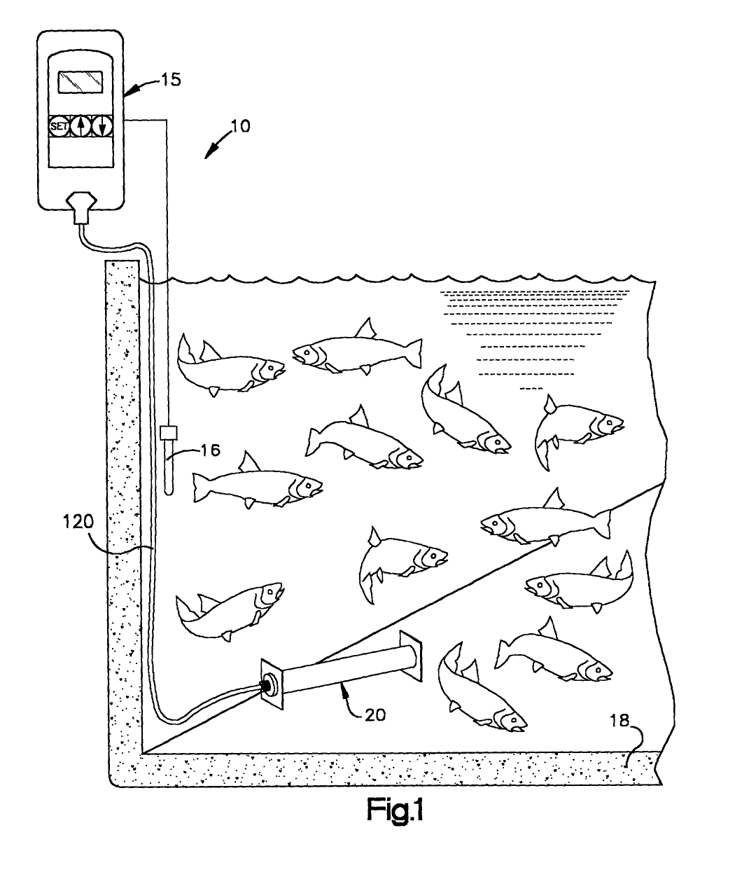

FIG. 1 depicts an overview of an aquaculture heating system 10 constructed in accordance with the present invention. A submersible heater 20 is submerged in an aquaculture tank 18 and is connected to a controller body 15 that in turn plugs into a standard G.F.I. 120 volt (or other appropriate voltage) AC outlet (cord and outlet not shown). While this description will refer to use in an aquaculture tank, the present invention may also be used in other large scale aquatic systems which require industrial grade heaters such as decorative ponds. A temperature probe 16 measures the temperature of the water in the tank 18 and communicates the temperature to the controller 15. The controller 15 provides power to the heater 20 when the tank temperature measured by the probe 16 falls below a user preset value and continues to power the heater 20 until the desired temperature is reached. To install the heating system 10, the user simply places the heater 20 in the tank 18, plugs the heater into the controller 15, and sets the desired tank temperature on the controller. In an exemplary embodiment, the controller and plug have a unique configuration that prevents a heater not designed for use with the controller from being plugged into the controller.

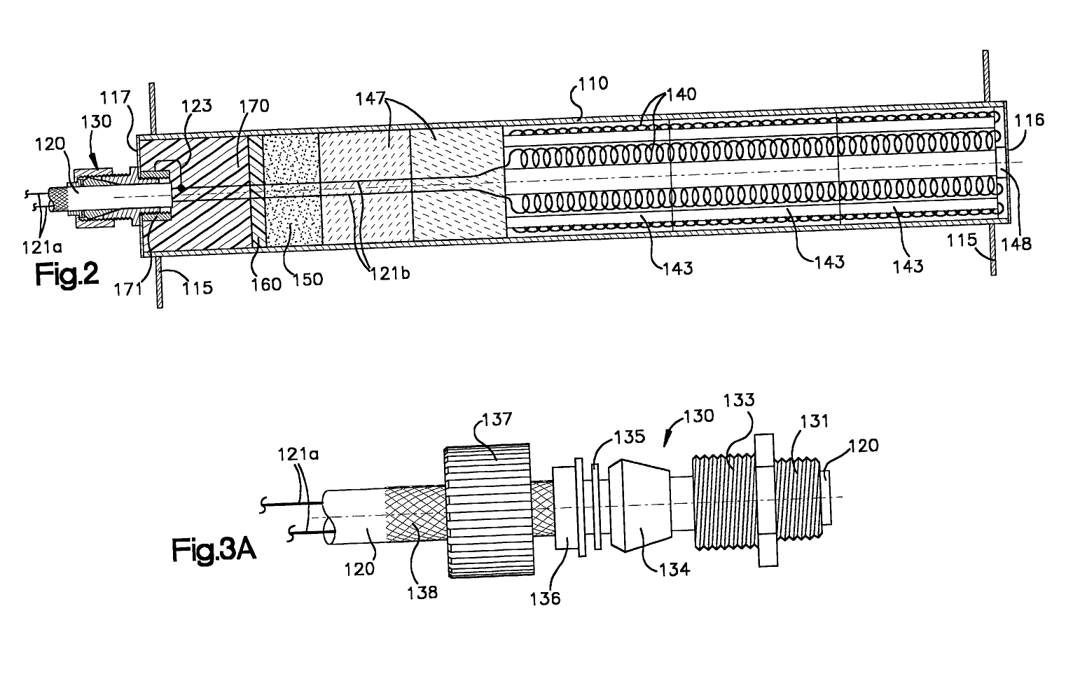

FIG. 2 illustrates the heater 20 of the heating system 10 in more detail. The heater 20 comprises a generally cylindrical heater body 10 having two standoffs 115 attached near either end, and a power cord 120 connected to the heater body 110 at one end by a watertight connector assembly 130 (such as Hubbel-Kellems liquid tight cord grip CG408NM). The heater 20 rests horizontally on the standoffs 115 when it is submerged in the aquaculture tank.

The heater body 110 is formed from a corrosion resistant metal such as stainless steel (such as A269 316 S.S. or A269 304 S.S. 0.065 inch thickness) or titanium (such as ASTMB 338 0.049 inch thickness) welded into a tube. The tube diameter is approximately ¼′ to two inches in an exemplary embodiment. A rear cap 116 is welded to the heater body 110 to seal the heater body against water intrusion. A front cap 117, adapted to receive the watertight connector 130, is also welded to the heater body.

The standoffs 115, each consisting of a generally square plate welded to the heater body 110, (four inches square in an exemplary embodiment) ensure that the heater body 110 does not contact the tank regardless of the orientation of the heater 20. While square plate standoffs are described here, other standoff configurations that allow for proper installation of the heater independent of the orientation of the heater 20 in the tank, such as rounded plates, may also be used in accordance with the present invention. A plurality of rolled flanges (not shown) may depend from the outer periphery of the plate standoff 115 to provide a smooth surface for contact with the tank 18.

A resistance heater 140 comprising a plurality of elements such as nichrome wire is located within the heater body 110. The heater 140 is insulated from the heater body by an end ceramic plug 148 and ceramic disks 143 which have channels disposed along their outer periphery for partially enclosing the elements of the heater 140. Packing powder(not shown), such as zircon sand, is distributed between the ceramic disks 143, 148 to further protect against contact between the heater 140 and the heater body 110 as well as to prevent contact between the heater elements. The heater 140 is energized by a pair of heater power leads 121b that extend from the watertight connector 130 to the heater elements. A plurality of ceramic disks 147 prevent the power leads 121b from contacting the heater body 110. A layer of sand 150 contained by a layer of epoxy 160 (such as E-Bond CA-110) locates the resistance heater 140 and its attending insulating ceramic disks 143, 147 within the heater 20.

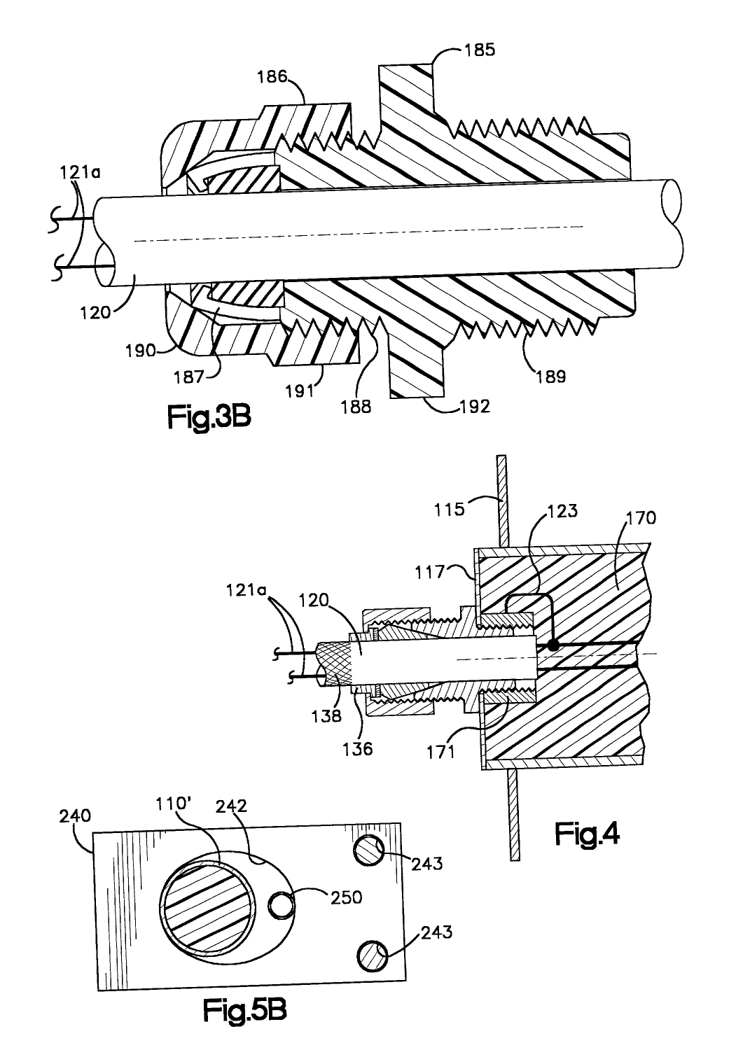

In proximity of the front cap 117, multiple sealing means prevent water from entering the heater 20. A sealant material 170 (such as Loctite E-60NC Epoxy Potting Compound) surrounds and seals the power leads 121b and fills the volume between the epoxy 160 and the front cap 117. Referring now to FIGS. 2 and 4, the front cap 117 comprises a bushing 171 having an internally threaded NPT (National Pipe Taper) configuration fixed (such as by welding) to the internal surface of the front cap. Referring now to FIGS. 2 and 3A, the watertight connector 130 threads into the bushing 171 by means of an externally threaded NPT connector body portion 131. The interaction between the internal NPT thread of the bushing 171 and the external thread of the connector body portion 131 provides a watertight seal.

The watertight connector 130 provides a means of connecting the power cord 120 (such as SJTW 14/3 round cord set) with its power leads 121a and a ground lead 123 to the heater 20. The power cord 120 extends through the watertight connector 130 and the bushing 171 and connects to the power leads 121b of the resistance heater 140 within the region of the heater containing the sealant material 170. The sealant material 170 therefore protects the connection between the power cord leads 121a and the resistance heater leads 121b. The ground lead 123 is electrically connected to the heater body 110 by fixation to the bushing 171.

A tapered rubber seal 134 fits within an externally threaded connector body portion 133 and provides a watertight seal around the power cord 120 when it is compressed by an o-ring 135 and a strain relief bushing 136. An internally threaded compression nut 137 threads onto the connector body portion 133 to compress the rubber seal 134, the o-ring 135, and strain relief bushing 136 and seal the power cord 120 to heater body 110 interface.

A mesh strain relief sleeve 138 extends from the compression nut 137 and tightly envelops the power cord 120. The strain relief sleeve 138 is made of a corrosion resistant material such as nylon and is connected to the strain relief bushing 136. When the power cord 120 is pulled in a direction out of the heater body 110, such as when one lifts the heater 20 by its cord 120, the mesh strain relief sleeve 138 tightens around the power cord 120 and transfers the pulling force from the power cord to the strain relief bushing 136 which is mechanically connected to the heater body 110 by compression nut 137. In this manner, the strain relief sleeve 138 prevents a pulling force on the power cord 120 from disturbing the internal electrical connections of the heater and the watertight seal of the heater 20.

Referring to FIG. 3B, an alternative strain relief configuration is depicted. A water tight connector 185 (such as Heyco compression fitting #3132) is adapted to be threaded into the heater body 110 via an externally threaded heater engaging portion 189 (not shown). The connector has a hexagonal cross section portion 192 that can be engaged by a wrench to tighten the connector into the heater. The connector 185 features an outer threaded portion 188 and an insulation engaging structure 187. The insulation engaging structure has fingers that taper to a close fit with the power cord 120. An internally threaded clamping nut 186 is adapted to thread onto the threaded portion 188 and includes a clamping portion 190 that engages the fingers of the insulation engaging structure 187 to tighten them against the power cord 120. In this manner, the water tight connector 185 prevents a pulling force on the power cord 120 from disturbing the internal electrical connections of the heater and the watertight seal of the heater 20

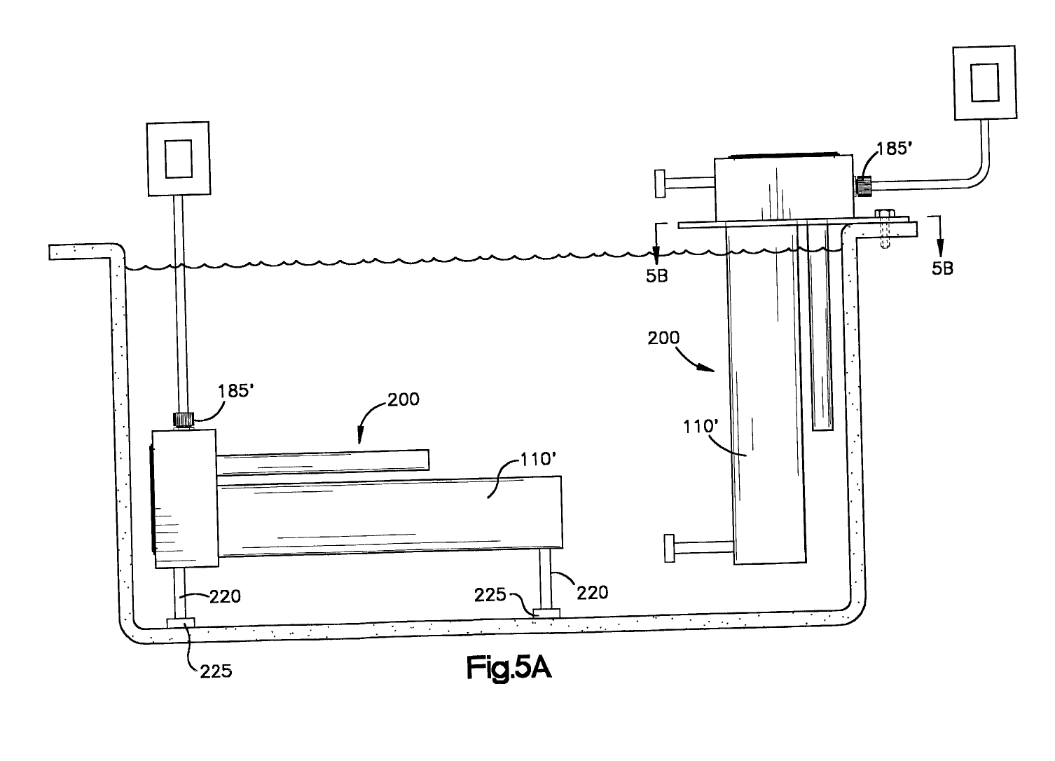

Referring now to FIGS. 5-7, an alternative embodiment of the present invention is illustrated. FIG. 5A illustrates a dual position submersible heater 200 installed at the bottom of a tank or on the tank wall. The dual position heater 200 features substantially the same resistance heater 140′ and heater body 110′ as that described for the embodiment depicted in FIGS. 1-4 and has substantially the same watertight connector 185′ extending perpendicular to the heater body.

The dual position heater 200 has support legs 220 that prevent the heater body 110 from contacting the bottom of the tank when the heater is installed for use on the tank bottom. The support legs 220 have bumper strips 225 made of a soft material such as rubber to prevent the mounting plate from tearing tank liners (not shown) or damaging the tank bottom. When the dual position heater 200 is used on the side of the tank, a mounting plate 240 (FIG. 5B) is installed by sliding the mounting plate over the heater body 110′. The mounting plate 240 consists of a metal plate that has an oval shaped opening 242 to allow a force fit around the heater body 110′ and a thermal protection housing 250. Mounting holes 243 are provided to accommodate connecting the dual position heater 200 to a tank side with screws.

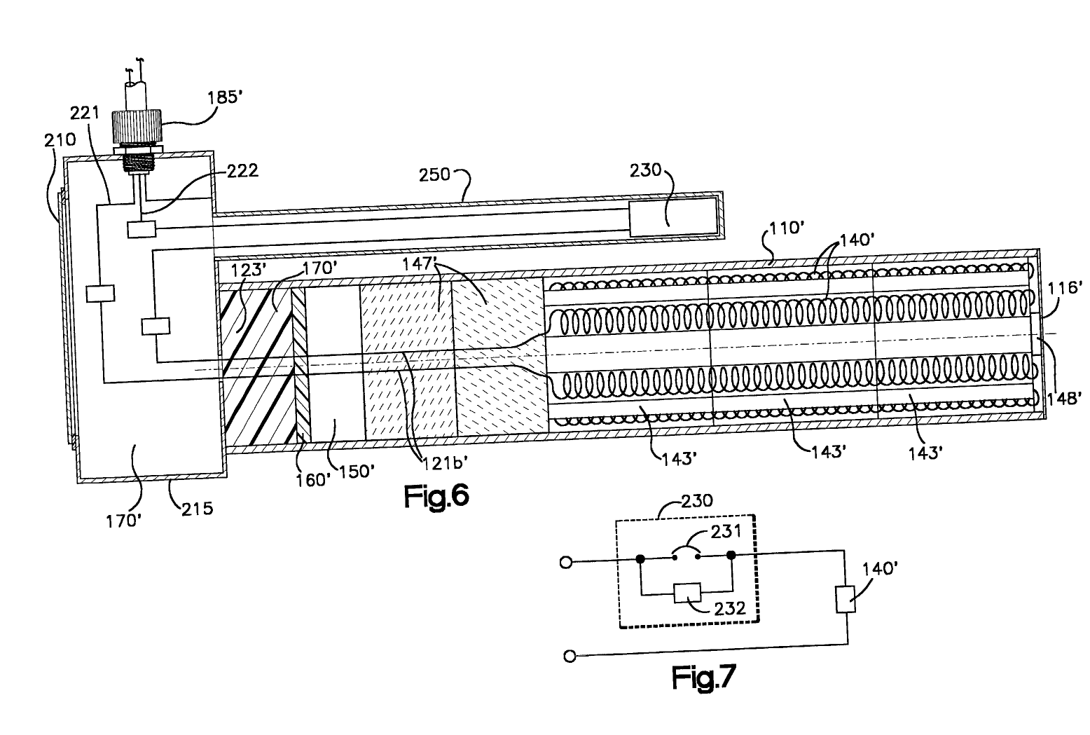

The internal components of the resistance heater 140′ for the dual position heater 200 are depicted in FIG. 6. The components are indicated by reference characters identical to those in FIG. 2, but with a prime designation. The description accompanying FIG. 2 regarding the resistance heater 140 provides adequate explanation for the heater 140′ and as such, no further description of the resistance heater is provided here. Likewise, the watertight connector 185′ and the multiple sealing means between the connector and heater body have already been adequately described in connection with FIG. 3B.

A sealing compartment 215 filled with sealant material 170′ is welded to the resistance heater body 110′. A sealed entry plate 210 is welded, screwed or otherwise attached to the sealing compartment 215 to prevent water entry. The watertight connector 185′ is threaded into the sealing compartment 215. Electric power wires 221 and 222 protrude into the sealing compartment 215 to make electrical connection with the resistance heater 140′ and with a thermal protection device 230 housed within the thermal protection housing 250.

The thermal protection device 230, schematically illustrated in conjunction with the resistive load of the resistance heater 140′ in FIG. 7 (commercially available as temperature control assembly model SR6 from Thermik Corporation), protects the resistance heater from overheating in the event that the water level in the tank becomes lower than the position of the heater body 110′. When the temperature of the resistance heater 140′ exceeds a predetermined temperature due to low water the thermal protection device 230 lowers the current supplied to the resistance heater to a neglible level thereby allowing the resistance heater to cool. The thermal protection device 230 maintains this low current condition until power has been removed from the heater 140′ for a relatively short cooling period. The thermal protection device 230 does not cycle power on and off like traditional bi-metal devices because a heating resistor 232 is placed in parallel to a bi-metal circuit breaker 231 contained in the thermal protection device. When the temperature of the resistance heater 140′ exceeds the switching temperature of the bi-metal circuit breaker 231, the breaker opens and current is transferred to the heating resistor 232. The current flowing across the heating resistor 232 generates heat thereby maintaining the temperature in the thermal protection device 230 above the reset temperature of the bi-metal circuit breaker 231 and preventing the closure of the breaker until power is removed from the heater 200 and the thermal protection device cools to below the reset temperature of the bi-metal circuit breaker. The resistance of the heating resistor 232 is such that it passes only a neglible amount of current on to the resistance heater 140′ so that the resistance heater will cool. In the event of a power outage, the thermal protection device 230 will conduct current to the resistance heater 110′ when power is restored without requiring a manual reset by an operator. It should be noted that while the thermal protection device 230 has been described in connection with the dual position heater 200, it may be used with the submersible heater 20 as well.

As can be seen from the preceding description, the present invention provides fully sealed, submersible heaters which are easy to install and offer a robust watertight connector. A user may transport the heater by carrying it by its cord and may install the heater by tossing the heater into the tank or pond to be heated or mounting the heater on the side of the tank. The orientation independent stand off configuration of the first described embodiment allows the heater to function properly in any horizontal orientation while the second described embodiment can be located on the bottom or side of the tank. The thermal protection device provides protection from the effects of circuit breaker cycling in a low water condition while providing an automatic restoration of power after an outage.

Although the invention has been described with a certain degree of particularity, it should be understood that various changes can be made to those skilled in the art without departing from the spirit or scope of the invention as hereinafter claimed.

I claim:

1. A portable, submersible heater for heating water in an aquaculture water container, said container having a plurality of containment surfaces, said heater comprising:
a) an electric resistance heater enclosed in a heater body;
b) at least one standoff member fixed to said heater body for preventing contact between said heater body and at least one of said containment surfaces;
c) a power cord connected to said resistance heater and entering said heater body through a cord to heater interface, said power cord having an external cord section located outside said heater body and an internal cord section located within said heater body;
d) multiple sealing means for preventing water from entering said heater body at said cord to heater interface; and
e) strain relief means for transferring a pulling force on said external cord section away from said internal cord section.

2. The heater of claim 1 wherein said at least one standoff member is configured such that said standoff member prevents contact between said heater body and said at least one of said containment surfaces regardless of the orientation of said heater within said container.

3. The heater of claim 1 wherein said heater body is cylindrically shaped and said at least one standoff member comprises a pair of standoff plates disposed near either end of said body.

4. The heater of claim 1 wherein said heater body is cylindrically shaped and said cord to heater interface is located at a first end of said heater body.

5. The heater of claim 4 wherein said multiple sealing means comprise a sealing material disposed within said first end of said heater body.

6. The heater of claim 5 wherein said sealing material is a potting compound.

7. The heater of claim 1 wherein said cord to heater interface comprises a connector engaging said heater body.

8. The heater of claim 7 wherein said multiple sealing means comprise a water tight thread engagement between said connector and said heater body.

9. The heater of claim 8 wherein said water tight thread engagement comprises a Nation Pipe Taper thread.

10. The heater of claim 7 wherein said multiple sealing means comprise at least one seal within said connector for sealing around said external cord section.

11. The heater of claim 1 wherein said heater body is cylindrically shaped and said cord to heater interface is a water tight connector disposed at a first end of said body and said multiple sealing means comprise:
a) a sealant material disposed within said heater body at said first end of said heater body;
b) an internal seal disposed within said connector for sealing around said external cord section and wherein said connector comprises a sealing thread portion for engaging said first end of said heater body; and
c) a threaded connector fixed to said first end of said heater body for providing sealing engagement with said sealing thread portion of said connector.

12. The heater of claim 11 wherein said sealant material comprises potting compound.

13. The heater of claim 11 wherein said sealing thread portion and said threaded connector comprise an NPT thread.

14. The heater of claim 1 wherein said cord to heater interface comprises a water tight connector and said strain relief means comprises a mesh sleeve disposed closely around said external cord section and connected to said water tight connector such that when a pulling force is applied to said external cord section said mesh sleeve tightens and grips said cord thereby transferring said pulling force to said connector instead of said internal cord section.

15. The heater of claim 1 wherein said cord to heater interface comprises a water tight connector and said strain relief means comprises an externally threaded portion on said water tight connector including an insulation engaging portion at a distal end to said heater that includes fingers that taper to a close fit with said cord and an internally threaded clamping nut that engages the externally threaded portion and coacts with said insulation engaging portion to force said fingers into a tight fit around said cord such that said cord is retained in said fingers thereby transferring a pulling force on said external cord section to said connector instead of said internal cord section.

16. The heater of claim 1 further comprising a controller connected to said power cord for controlling the operation of said heater.

17. The heater of claim 1 further comprising a mounting member coupled to said heater body and adapted for connection to a side of said container above said water.

18. The heater of claim 17 wherein said mounting member comprises a stamped metal plate having an opening sized to have a force fit with said heater body.

19. The heater of claim 1 wherein said heater body is cylindrically shaped and said cord to heater interface is located in proximity to a first end of said heater and wherein said power cord protrudes radially from said heater.

20. The heater of claim 1 further comprising a thermal protection device in electrical communication with said resistance heater.

21. The heater of claim 20 wherein said thermal protection device comprises a resistor electrically connected in parallel with a bi-metal switch having a trip temperature above which said switch moves to an open circuit condition and a reset temperature below which said switch conducts current.

22. The heater of claim 21 wherein said resistor generates heat when power is being supplied to said resistance heater and said switch is in said open circuit condition to maintain the temperature of said switch above said reset temperature.

23. A portable, submersible heater for heating water in an aquaculture water container by resting said heater on a bottom surface of said container comprising:
a) an electric resistance heater enclosed in a cylindrically shaped heater body;
b) a pair of standoff plates fixed in proximity of either end of said heater body for preventing contact between said heater body and said bottom surface of said aquaculture container regardless of the orientation of said heater within said container;
c) a power cord connected to said resistance heater and entering said heater body through a water tight connector at a first end of said heater body, said cord having an external cord section located outside said heater body and an internal cord section located within said heater body;
d) multiple sealing means for preventing water from entering said heater body comprising:
i) a sealant material disposed within said heater body at said first end of said heater body,
ii) an internal seal disposed within said connector for sealing around said external cord section and wherein said connector comprises a sealing thread portion for engaging said first end of said heater body; and
iii) a threaded connector fixed to said first end of said heater body for providing sealing engagement with said sealing thread portion of said connector; and
e) a strain relief means comprising a mesh sleeve disposed closely around said external cord section and connected to said water tight connector such that when a pulling force is applied to said external cord section said mesh sleeve tightens and grips said cord thereby transferring said pulling force to said connector instead of said internal cord section.

24. The heater of claim 23 wherein said standoff plates are square.

25. The heater of claim 23 wherein said sealant material is potting compound.

26. The heater of claim 23 further comprising a controller connected to said power cord for controlling the operation of said heater.

27. A portable, submersible heater for heating water in an aquaculture water container by resting said heater on a bottom surface of said container comprising:
a) an electric resistance heater enclosed in a cylindrically shaped heater body;
b) a pair of standoff plates fixed in proximity of either end of said heater body for preventing contact between said heater body and said bottom surface of said aquaculture container regardless of the orientation of said heater within said container;
c) a power cord connected to said resistance heater and entering said heater body through a water tight connector at a first end of said heater body, said cord having an external cord section located outside said heater body and an internal cord section located within said heater body;
d) multiple sealing means for preventing water from entering said heater body comprising:
i) a sealant material disposed within said heater body at said first end of said heater body,
ii) an internal seal disposed within said connector for sealing around said external cord section and wherein said connector comprises a sealing thread portion for engaging said first end of said heater body; and
iii) a threaded connector fixed to said first end of said heater body for providing sealing engagement with said sealing thread portion of said connector; and
e) a strain relief means comprising an externally threaded portion on said threaded connector including an insulation engaging portion at a distal end to said heater that includes fingers that taper to a close fit with said cord and an internally threaded clamping nut that engages that externally threaded portion and coacts with said insulation engaging portion to force said fingers into a tight fit around said cord such that said cord is retained in said fingers thereby transferring a pulling force on said external cord section to said connector instead of said internal cord section.

28. The heater of claim 27 wherein said standoff plates are square.

29. The heater of claim 27 wherein said sealant material is potting compound.

30. The heater of claim 27 further comprising a controller connected to said power cord for controlling the operation of said heater.

31. A portable, submersible heater for heating water in an aquaculture water container, said container having a plurality of containment surfaces, said heater comprising:
a) an electric resistance heater enclosed in a heater body;
b) at least one standoff member fixed to said heater body for preventing contact between said heater body and at least one of said containment surfaces;
c) a thermal protection device in electrical communication with said resistance heater comprising a resistor electrically connected in parallel with a bi-metal switch having a trip temperature above which said switch moves to an open circuit condition and a reset temperature below which said switch conducts current and wherein said resistor generates heat when power is being supplied to said resistance heater and said switch is in said open circuit condition to maintain the temperature of said switch above said reset temperature;
d) a power cord connected to said resistance heater and entering said heater body through a cord to heater interface, said power cord having an external cord section located outside said heater body and an internal cord section located within said heater body;
e) multiple sealing means for preventing water from entering said heater body at said cord to heater interface; and
f) strain relief means for transferring a pulling force on said external cord section away from said internal cord section.

32. The heater of claim 31 further comprising a mounting member comprising a stamped metal plate having an opening sized to have a force fit with said heater body.

33. The heater of claim 31 wherein said heater body is cylindrically shaped and said cord to heater interface is located in proximity to a first end of said heater and wherein said power cord protrudes radially from said heater.

34. The heater of claim 31 wherein said at least one standoff member comprises rubber strips along at least one edge of said member.
